(19) United States
(12) Patent Application Publication
(10) Pub. No.: US 2002/0026374 A1
(43) Pub. Date: Feb. 28, 2002

(54) Comprehensive third-party transactional processing and payment in an online environment

(76) Inventors: Vincent B. Moneymaker, Manhattan Beach, CA (US); Anthony Gaw, Henderson, NV (US)

Correspondence Address: VINCENT B. MONEYMAKER, 700 SOUTH FLOWER STREET, SUITE 2102, LOS ANGELES, CA, 90017, US

(21) Appl. No.: 09/846,652

(22) Filed: May 1, 2001

Related U.S. Application Data
(60) Provisional application No. 60/201,337, filed on May 2, 2000.

(51) Int. Cl. G06F 17/60

(52) U.S. Cl. 705/26

(57) ABSTRACT

The present invention provides a method and system for enabling and processing transactions between parties in a computer-networked ‘online’ environment and then amalgamating orders which are remunerated in an online environment across an array of merchants so as to reduce transactional costs for facilitators which implement the present invention, as well as for merchants who participate in the implementation of the system. The present invention further enables implementing facilitators to track transactions which occur in an online environment but which are paid either in an offline environment or in an online environment and to then receive remuneration for both types of transactions from transactions which are processed by the facilitator throught its transactional gateway. Additionally, the present invention allows implementing facilitators to eliminate the need to receive payment for their services via invoiced accounts receivables by enabling such facilitators to receive payment for their services directly from orders which the facilitator processes on behalf of participating merchants. This method and system also enables merchants to achieve an ‘online’ presence while at the same time avoiding costs of sale which are associated with maintaining an online presence until a sale of a product or service actually occurs. Relying on the method and system provided for in the present invention, a facilitator can also expand the services it provides to participating merchants while at the same time completely avoiding accounts receivables payment issues vis-a-vis participating merchants. As a result, the present invention enables implementing facilitators to reduce online transactional costs for both themselves and participating merchants while at the same time enabling merchants to obtain an online presence in an efficient and cost effective manner.

### CROSS-REFERENCES TO RELATED APPLICATIONS

This application is entitled to the benefit of Provisional Patent Application Ser. No. 60/201337, filed May 2, 2000.

### STATEMENT REGARDING FEDERALLY SPONSORED RESEARCH OR DEVELOPMENT

Not applicable.

### BACKGROUND OF THE INVENTION

The present invention relates to commercial transactions occurring via electronic networks such as local area networks, wireless networks, intranets and the Internet environment.

Over the last several years, large scale computer networks, such as the Internet, have become an important place for businesses to attract and obtain new customers. Because computer networks such as the Internet are accessible twenty-four hours a day, seven days a week, companies' goods and services can be made available for purchase at anytime over such networks. Additionally, because such networks are accessible wherever there is an electronic connection (e.g. a wireless connection), companies can effectively sell their goods and services wherever a potential customer has access to an electronic connection to a network. Other advantages of doing business over computer networks include the ability of consumers to obtain information about particular goods and services at anytime without employees having to be available to disseminate such information.

Many businesses have taken advantage of the benefits that are attendant with having a computer-networked presence (the term ‘computer-networked’ is referred to hereafter as “online”) which customers can access twenty-four hours a day, seven days a week. And, in fact, a number of companies have come into existence for the express purpose of facilitating this process of putting other company's goods and services for sale online.

However, for a great number of businesses, they simply have not been able to enjoy the business advantages offered by having an around-the-clock online presence because the costs associated with conducting transactions in this manner have proven to be too high. In particular, for many small businesses, the cost of doing business online has been prohibitively expensive because of the high merchant account discount rates charged by third party credit card processors, as well as by electronic fund transfer (“EFT”) processors, to process transactions which occur in an online environment such as the Internet. Indeed, when chargeback charges are taken into account for transactions which are subsequently rescinded at the request of a particular consumer, it simply does not make economic sense for many small businesses to establish an online presence. Further adding to the problems faced by many businesses attempting to generate an online presence is the fact that the volume of sales associated with online purchases of products and/or services is typically high enough that an actual profit can be made. Indeed, the volume of sales generated by online business sites have generally been directly related to the amount of name recognition a particular online site has. This has meant that, typically, only those companies with advertising budgets large enough to accommodate nationwide or worldwide advertising campaigns have been able to generate the sort of name recognition necessary to increase transactional volumes to the point that online business sites become sustainable.

In effect, what this has meant is that online commerce works for large scale businesses that sell goods on a nationwide or worldwide basis, but does not work sufficiently well for small businesses that sell their goods and services locally. Because small, local businesses cannot attract the volume of sales necessary to offset the higher transactional costs associated with conducting commerce in an online environment, many such businesses have made the decision not to have an online presence.

Some companies which facilitate a presence for businesses in an online environment have tried to counteract the problem associated with having to engage in significant advertising in order to attract sufficient traffic to justify the costs associated with being online. They have done this by pooling businesses together via a single online site and then advertising that single site so that the small businesses which have joined the site can get the benefit of such an advertising campaign. Examples of this type of endeavor have included ‘food.com’, which specializes in putting restaurant online so that their respective menu items can be ordered by interested consumers.

The problem with such sites, however, is that they duplicate what can already be done more simply with a fax machine. This is the case because on such sites if a consumer wants to pay for his or her goods or services via a credit card or electronic finds transfer card (the term electronic fund transfer is referred to hereafter as “EFT”), this information is first collected by the online facilitator and then it is sent to the restaurant from whom the customer has ordered his or her food. The restaurant receiving this order then has to submit the accompanying credit card or EFT data through its own third-party credit card and/or EFT processor. As a result, significant delays are attendant in any such purchase because the order information, including the credit card and/or EFT related data entered by the consumer, first has to be received by the online facilitator. Then, this data has to be transferred either by phone or fax, or by some other means, to the small business which is actually going to fulfill the order. Then the small business which receives this information has to run the credit card and/or EFT data it receives through its own third-party credit card or EFT transactional processor. And after all of this is done, if the credit card order or EFT order is rejected, either through a data entry mistake, or because the consumer's request has been rejected, the business which received the order has to contact the consumer and inform him or her that his or her purchase was rejected. Thus, not only are there numerous steps for miscalculation in this process, but there is also a significant chance of upsetting customers who will not receive word until much later that their order has been rejected. Further, the small business and its consumer are going through the exact same process that would occur if the consumer simply faxed his or her order into the restaurant. As a result, no matter what avenue a small business takes to develop an online presence, significant problems face such a business. These problems include high transactional costs, inefficient distributions of information, ordering delays, and magnified probabilities that mistakes will occur in customer orders. Indeed, these problems are often times so significant that they effectively frustrate a business's best efforts to develop an online presence.

### SUMMARY OF INVENTION

In order to solve the aforementioned problems, a system is needed which enables transaction costs to be reduced for companies which desire to do business online, while at the same time providing a more efficient and mistake free distribution of information to such companies and their customers. Further, such a system needs to be made economical to the point that it makes business sense for facilitators which are enabling companies to go online to implement such a system.

An object of the present invention is to satisfy such a need by providing a method and system whereby transactions are enabled between consumers and merchants in an online environment and then such transactions are amalgamated across an array of merchants and processed through a single transactional gateway. Utilizing the present invention, transactional costs for credit card and/or EFT orders, or any other type of electronic payment, which occur in an online environment, can be reduced across an array of merchants because orders for their goods and services are collectively transmitted through a single transactional gateway, rather than being processed separately through transactional gateways applicable to each particular merchant.

Another object and advantage of the present invention is that, by processing electronic orders through a single transactional gateway, this process eliminates mistakes and delays associated with transmitting credit card and/or EFT data, or other electronic payment data, to each particular merchant who receives an online order and who is then forced to transmit the received credit card and/or EFT data to his or her own third-party credit card processor.

Another object and advantage of the present invention is that it enables facilitators (which have created online presences for participating merchants) to avoid accounts receivables issues with such merchants by receiving remuneration directly from the orders which the facilitator processes for participating merchants. Additionally, the present invention enables facilitators to track both credit card sales and EFT sales on the one hand, and cash sales on the other hand, and then receive direct remuneration for both types of sales even though cash sales are collected directly by the participating merchant. Thus, the entire problem of collecting on accounts receivables is avoided by facilitators which implement the present invention Another object and advantage of the present invention is that it allows businesses to profit in an online environment while enabling them to maintain their separateness as distinct entities, without, at the same time, having to actually create an autonomous online presence, which would necessarily result in significant technical expenses for each participating business. Additionally, by utilizing the present invention, businesses can engage in profitable online transactions even where sales volumes for each particular business are low because the present invention enables online transactional costs to be reduced, while at the same time creating an environment whereby a merchant's costs of sale are not actually incurred until an online sale of a product or service actually occurs.

Further objects and advantages of this system include the ability to enable facilitators of the present invention to expand the services they provide to participating merchants (such as, for example, providing computer services, networking services, advertising services and/or distributions services, to name just a few of the services that can be provided) and, while doing this, implementing facilitators can continue to avoid the problem of having to collect on accounts receivables due the facilitator for providing such services. Thus, when a service is provided, an implementing facilitator can simply look to the transactions being processed on behalf of a participating merchant for remuneration of any amounts owed for any other service or services which are being provided to the merchant. The aforementioned objects, features and advantages, in addition to still further objects and advantages of the present invention, will become apparent from a consideration of the ensuing description and drawings.

### BRIEF DESCRIPTION OF THE DRAWINGS

FIG. 1 is a block diagram illustrating an embodiment of the present invention.

FIG. 2 illustrates a data form which may be used in an embodiment of the present invention.

FIG. 3 is a flow chart illustrating a routine for enabling and processing online transactions where a party receives direct remuneration in satisfaction of the completed transaction.

FIG. 4 is a flow chart illustrating a routine for enabling and processing online transactions where a party does not receive direct remuneration in satisfaction of the completed transaction.

FIG. 5 is a flow chart illustrating a routine for tracking, finalizing, and accounting for payments, including bidirectional payments, on online transactions in an integrated single service provider environment.

FIGS. 6A-B illustrate, respectively, database and accounting routines which may be used in an embodiment of the present invention for purposes of processing, tracking, finalizing, and accounting for payments, including bidirectional payments, on online transactions in an integrated single service provider environment.

### DETAILED DESCRIPTION OF THE INVENTION

The present invention provides a method and system for processing transactions between separate parties, such as between a consumer and a merchant, which are initiated in an online environment, and then remunerated either directly between the parties in an online environment, or indirectly, through a facilitator, such as a site developer or administrator, in an online environment. Transactions which are remunerated through a facilitator in an online environment may then be amalgamated, across an array of merchants, and processed through a single transactional gateway, such as a merchant account, so as to achieve operational cost reductions. Utilizing the present invention, transactions (no matter whether they are remunerated in an online or offline environment) may then be tracked, accounted for, and finalized vis-a-vis particular fulfilling parties, with a result being that fulfilling parties receive payment with respect to their particular online transactions at the reduced transactional cost rate which is available to all of the fulfilling parties when all of their online transactions are pooled together. At the same time, a facilitator implementing the present invention may utilize currency or other forms of exchange, which are received in payment of online transactions, to credit costs, fees, and/or expenses associated with the transactions of particular fulfilling parties, no matter whether their transactions have been remunerated in an online or offline environment. A facilitator implementing the present invention may also utilize such currency, or other forms of exchange, which are received, to credit costs, fees, and/or expenses associated with other services or goods which have been provided to a particular fulfilling party. After such costs, fees, and/or expenses are credited, the facilitator can then remit to the fulfilling party the remaining monies due that particular party. As a result, a facilitator implementing the present invention does not have to wait for its invoices to the fulfilling parties to be themselves fulfilled. Rather, a facilitator can invoice a fulfilling party, such as a merchant, for transactions which have been processed and finalized and then fulfill the invoice itself from the monies received for transactions which have been processed by the facilitator through the single transactional gateway.

Thus, as an example, the present invention will enable single online site facilitators to service and pool credit card orders of goods or services from multiple businesses, such as restaurants. This, in turn, will result in a lower merchant account discount rate being achieved for each restaurant's orders, as opposed to the higher rate any particular restaurant would have to pay on its orders if the restaurant operated an online site on its own. The advantage to this aspect of the present invention is that it will result in reduced transactional costs not only for the facilitator but also for participating businesses, thereby increasing cost efficiencies for both, without sacrificing either the facilitator's or the participating merchant's service efficiency.

Additionally, the present invention will enable online orders to be accounted for, and finalized, no matter whether a particular order is paid for in person (e.g. by way of cash), or paid for online (e.g. by way of credit card). Once finalized, a facilitator will then be able to receive payment, for the online services he or she has provided, directly from the merchant account monies the facilitator receives in satisfaction of approved credit card and/or electronic fund transfer orders. As a result, a facilitator will be able to avoid having to invoice for the services he or she has provided and then wait for payment, as most service businesses currently have to do. Instead, the facilitator will be able to receive payment upfront for all of the online services he or she has provided, no matter whether they have involved orders which have been paid offline to the merchant, or online to the facilitator. Having deducted the monies owed to him or her, a facilitator can then remit any remaining monies, which are owed to the merchant, directly to that merchant.

Thus, the present invention amounts to an integrated and comprehensive system and process which single online facilitators may use in order to increase order processing efficiencies across an array of businesses, while at the same time decreasing payment uncertainties for both the facilitator and participating businesses. At the same time, processing, tracking and accounting efficiencies can be increased for the facilitator and participating businesses without incurring any corresponding decrease in fulfillment efficiencies.

In one embodiment of the present invention, a web page or pages (the singular and plural of the term ‘web page’ are referred to collectively hereafter as “web page”), is developed, and/or administered, by a single online facilitator for one or more parties so that their respective goods or services can be offered for sale online to interested parties. Each web page, which has been developed for a particular offering party, is able to invoke an ordering form, or forms, which enables interested parties to select and then order items or services which are offered for sale on the referenced web page. In order to begin the ordering process, an interested party calls the desired web page for viewing on the interested party's computer by inputting a unique universal resource locator identifier (e.g. “www.example.com”) into a location bar, or other such search mechanism, on the interested party's computer browser (e.g. Internet Explorer 5.0 or Netscape Navigator 6.0). A computer browser (referred to hereafter as a “browser”) is an application specific computer program which enables an interested party to search for and display viewable interfaces, such as web pages, which may include additional programming and information manipulation capabilities. Browsers are referred to in the present embodiment of the invention because they are the type of application most commonly used to search for information, including web pages, in an online environment. However, any application which is capable of searching for and obtaining graphical and text-based information in an online environment could be utilized with the present invention. Thus, the present invention is not restricted to being used only with or by browsers.

Once the universal resource locator identifier (referred to hereafter as “URL”) for the desired web page is inputted into a browser's search mechanism, and the search mechanism is then invoked, the request for the desired web page is then sent over the Internet utilizing a computer language protocol. In this case, the protocol utilized is the HyperText Transfer Protocol (referred to hereafter as “HTTP”). The request for the desired web page is then routed based on its URL identifier to a server supporting the particular web page which the interested party desires to view. The server receiving the routed request for the desired web page responds by transmitting the requested web page back to the interested party who has requested the web page. The web page is then received by the interested party and defined for viewing and use on the interested party's computer screen by means of a computer language such as HyperText Markup Language (referred to hereafter as “HTML”), which embeds certain defined commands, or tags, in the file or files comprising the desired web page. These tags, in turn, control how the text, graphics, controls and other features associated with the web page are displayed and used by the interested party via his or her computer screen.

Once the desired web page is downloaded so as to be viewable on the interested party's computer screen, the interested party proceeds to select the goods or services he or she desires to order. The selected items or services are then inputted into a final ordering form which may be invoked through the desired web page. The final ordering form will also typically include textboxes for the interested party to include his or her name, address, phone number, and email address. The final ordering form will also enable an interested party to select whether he or she is going to pay online, by means of a credit card or EFT, or whether the interested party is going to pay offline, by means of cash or check. If the interested party chooses to pay online, the interested party will be able to fill in textboxes setting forth the interested party's applicable credit card or EFT identifying information. The final ordering form will also enable an ordering party to indicate whether he or she wants his or her order delivered, or whether the order is to be picked up by the interested party.

Once the final ordering form is completed, the interested party will then submit the ordering form for fulfillment. If the order involves remuneration, which will be received directly by a merchant in an offline environment, such as in the form of a cash payment made on a pickup order, then the order is uploaded, online, to the server. Once received at the server, the relevant details of the order are then stored in an order database for retrieval. Such details may include the specifics of the items or services ordered, including their respective types, amounts, and quantities, as well as any information which is necessary to properly identify the ordering party. After the details of the order are stored, or even at the same time the details of the order are stored, a message is then emailed back to the ordering party so as to confirm that the order has been received and will be fulfilled. the order is also emailed or faxed to the party or business from whom the items or services have been ordered so that the order may be fulfilled.

If the order involves remuneration which will be received indirectly by a merchant in an online environment, such as in the form of an online credit card or EFT transaction that is processed through the facilitator, then the order is uploaded to a server and sent to a third party processor. When the order is received at the server, the relevant details of the order are stored in a order database for retrieval purposes. The order is then transmitted to a third party credit card or EFT processor, where the order is then either approved or declined, depending on whether the order sets forth correct identifying information, or whether funds or credit, to pay for the requested goods or services, are available in the particular amount required. If the order is denied, then the denial, along with the details relating thereto, is sent to the server and recorded in the order database. From the server, a message is then downloaded to the interested party which informs him or her of the details of the denial.

If, on the other hand, the order is approved, then the approval, along with any relevant details, such as the amount approved and the approval identification number, are downloaded to the server and inputted into the order database, in conjunction with the order details previously entered into the database. At the same time, or after the details of the order are stored in the order database, a message is emailed back to the ordering party to confirm that the order has been received and will be fulfilled. The order is also emailed or faxed to the party from whom the items or services have been ordered so that the order may be fulfilled. One skilled in the art will, thus, recognize the foregoing as an ordering system involving a shopping cart which allows items or services to be ordered online, a third party processing system for approving or denying credit card and/or EFT based orders, and an email/faxing system for transmitting orders so that they can be fulfilled.

Orders which are stored in an order database may have the details making up each respective order set forth in a simple text file format. Each element of the order, such as the name of the ordering party, may then be set forth in a tab delimited format so that alike elements for separate orders will be aligned in the same column. Thus, the order database may appear as a simple text file containing columns of similar elements, which, when viewed across a particular row, contain the complete details for one order. On a periodic basis, orders which are imported into the order database in this manner may then be sorted so that orders which were fulfilled by a particular party are grouped together by that party. Organizing the orders in this way, each set of orders which applies to a particular party, or merchant, will be grouped together so that every order which has been fulfilled by a particular party or merchant, over a particular period of time, is categorized based on the identity of the fulfilling party or merchant (the terms ‘party’ and ‘merchant’ are collectively referred to hereafter as “merchant”). Once sorted by merchant, orders may then be further sorted into two subgroups. One subgroup may be of orders which have been remunerated in an offline environment, whereas the other subgroup may be of orders which have been remunerated in an online environment.

Once orders for a particular merchant have been segregated into subgroups which are based on the manner in which the orders were remunerated, these subgroups may then have their respective transactional amounts separately summed. The summed amount for each subgroup of orders may then be placed, as an element, in a concluding row, in a text file, which is composed of not only this element, but also any other relevant elements which are static across each column of transactional information. The orders composing each subgroup may also remain un-summed. Either way, a single concluding row for a subgroup which has been summed, or all of the rows for a subgroup which has not been summed, may then be imported into a predefined tagging environment. In this environment, each relevant piece of transactional information is tagged with predefined codes so as to identify whether the information relates to an order, or orders, which were remunerated either in an offline environment, or in an online environment. Alternatively, each relevant piece of transactional information may be imported into a columnar defined format where predefined headings are used, rather than tags, to identify relevant pieces of transactional information which relate to an order, or orders, which were remunerated in either an offline environment, or in an online environment. Once the transactional information relating to an order, or set of orders, is formatted in such an environment, the transactional information may then be imported into a computer accounting application which has been programmed to recognize the predefined set of tags or headings which are being used.

Using such a predefined set of tags or headings, transactional information may then be cycled through the facilitator's chart of relevant accounts so that orders remunerated offline are accounted for, and the fees relating to the online facilitation of such orders are calculated. At the same time, the facilitator's accounting application is programmed, through the use of the predefined set of tags or headings, to reflect the fact that remuneration on such orders was received offline by the particular merchant who fulfilled the order, rather than by the facilitator who actually enabled the transaction to take place. In contrast, transactional information relating to orders which have been remunerated online, through the facilitator, may be cycled through the facilitator's chart of relevant accounts so as to reflect the fact of such direct payment, as well as to account for orders paid in this fashion, along with the fees due on such orders.

Once orders for a particular merchant, which have taken place over a particular period of time, are imported into an accounting application in the afore-referenced manner, the fees due the facilitator for orders which have been paid, both online to the facilitator and offline, to the merchant may be calculated in an integrated fashion. The fees due for facilitating both types of transactions may then be collectively deducted from the monies received by the facilitator on orders which were paid for online by means of a credit card or EFT. Sums which remain after the deduction of such fees may then be remitted to an applicable merchant by means of checks, which are automatically generated through the use of the afore-referenced predefined tags or headings, or, alternatively, through the use of EFT-invoked direct deposits to an applicable merchant.

In order to enable this process to take place, participating merchants are treated as both customers and vendors for accounting purposes. Participating merchants are treated as customers to the extent that fees are charged to them for online services which are provided to them. At the same time, and in the same accounting context, merchants are also treated as vendors to the extent that monies are remitted to them on orders which they fulfilled, but which were satisfied by payment to the facilitator from the applicable third party credit card or EFT processor who approved the particular transaction.

Separate liability accounts are also set up for each participating merchant, as well as separately defined service charge accounts for each merchant. These accounts may be further segregated into accounts involving offline-related liabilities and charges and accounts involving online-related liabilities and charges. The purpose of such an arrangement is to allow orders to be tracked on an individual or cumulative basis by the particular merchant involved, as well as by the type of order or service charge involved. This, in turn, enables profits, as well as transactional costs and expenses, to be calculated for orders received with respect to particular merchants, or types of merchants or orders, or types of orders, or even across all orders relating to all participating merchants.

The present invention, thus, creates a process and system which enables a single online facilitator to process orders for a multitude of businesses. However, as opposed to what might be expected, the transactional costs for processing such orders will not increase as the volume of the orders increases. Rather, transactional costs will actually decrease as volume increases. At the same time, orders are able to be tracked and accounted for no matter whether they are paid for on an online basis, or on an offline basis. And finally, facilitators which employ the present invention, so as to create online ordering environments for participating merchants, will be able to have their service fees (for both online and offline remunerated transactions) paid without having to invoice participating merchants, only to then have to wait for payment. Thus, the present invention creates a superior online operating environment which benefits both facilitators and participating merchants by reducing costs and increasing transactional efficiencies.

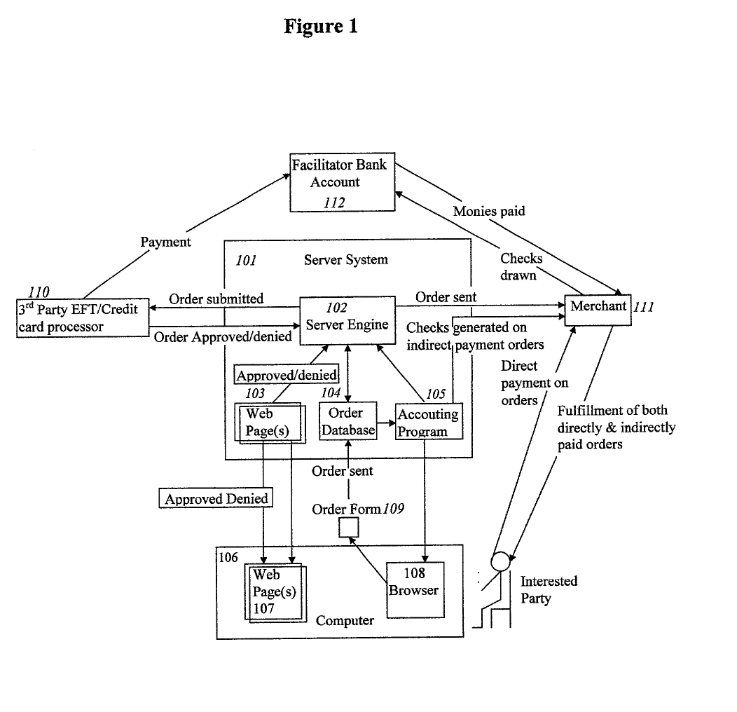

FIG. 1 is a block diagram illustrating an embodiment of the present invention. This embodiment illustrates the present invention in an online environment with desired web pages being requested by interested parties, from a facilitator's server, so as to enable such interested parties to order items and/or services from particular merchants whose goods or services are being offered for sale via the web pages which the facilitator has either developed or is administering. The block diagram breaks the present embodiment of the invention down into five parts. First, there is a server system 101, which is composed of a server engine 102, a web page(s) 103, an order database 104, and an accounting program 105. The ordering process begins with server engine 102, via server system 101, receiving an online request, for a particular merchant's web page, from an interested party 113 utilizing a computer language protocol such as HTTP or HTTPS. Server engine 102 responds to the request by downloading a web page(s) 103 to interested party 113's computer 106 so that the web page(s) 103 now resides on interested party 113's computer 106 as a web page(s) 107. Web page(s) 107 is then viewed on interested party 113's computer 106 by a browser 108. Interested party 113 then picks the items or services he or she wants from web page(s) 107, which results in these items or services being automatically inputted into an order form 109, which order form 109 also includes interested party 113's payment information and pickup or delivery instructions. Order form 109 is then uploaded from interested party 113's computer 106 to an order database 104. If order form 109 involves an order where payment will be made directly to a merchant 111, then the order information contained in order form 109 is sent, by means of server engine 102, directly to merchant 111 via an email or fax. The order which is set forth in order form 109 is then fulfilled and is either picked up by interested party 113, or the order is delivered to him or her. Either way, interested party 113 then directly pays merchant 111 for the ordered goods.

If order form 109 involves an order where payment will be made via a credit card, or EFT, in an online environment, then the order (after being entered into order database 104) is routed, via server engine 102, to a third party EFT/credit card processor 110 for approval or denial. If the order is denied, then a message is sent back through server engine 102, web page(s) 103, web page(s) 107, and browser 108, to interested party 113 which informs him or her that his or her order has been denied. On the other hand, if the order is approved, then the approval, along with any relevant details, such as the amount approved and the approval identification number, is transmitted back to server engine 102. Once transmitted to server engine 102, approved orders are then transmitted to merchant 111 for fulfillment. Such fulfillment is accomplished either by interested party 113 picking up his or her order, or having the ordered delivered.

While fulfillment is occurring, payment for online transactions is remitted from third party EFT/credit card processor 110 to a bank account 112, which is the bank account for the facilitator which has set up the ordering system illustrated in FIG. 1. Periodically, orders to merchant 111 are then segregated, based on whether they have been paid for offline or online, and then transmitted to an accounting program 105 in a tab delimited format, which utilizes predefined tags or headings in order to properly cycle the orders through accounting program 105. Based on the formatting and defining of the orders' details, a check is then generated and sent to merchant 111 to satisfy the monies owed to merchant 111 from bank account 112, less any fees due to the facilitator for all of the orders which have been processed, no matter whether they have been paid offline or online. This system, thus, enables orders to be processed in an integrated environment across a range of merchants no matter whether the merchants are to be paid directly in an offline environment, or indirectly, through the facilitator, in an online environment. The system also enables orders to be tracked and accounted for vis-a-vis an array of merchants while at the same reducing transactional costs, which may include processing costs, tracking costs and accounting costs, for both the facilitator and participating merchants.

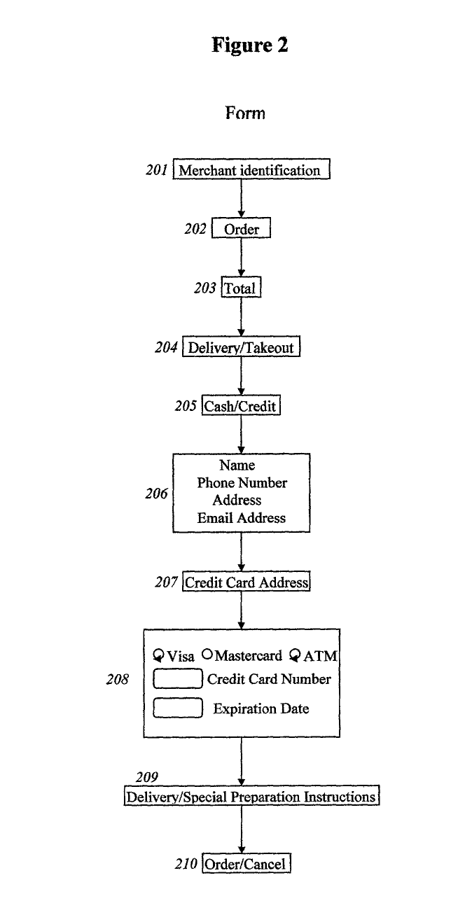

FIG. 2 illustrates a data form which may be used in an embodiment of the present invention. The data form is composed of the specific details which may comprise a particular interested party's purchase or service order. A section 201 contains information identifying the particular merchant the order is to be directed to. A section 202 contains the specific items or services which have been ordered by the interested party. A section 203 contains the total amount of the order, including taxes. A section 204 contains radio boxes which enable the interested party to indicate whether he or she wants to have the order delivered or whether it will be picked up. A section 205, in turn, contains radio boxes which enable the interested party to indicate whether he or she will be paying online, via a credit card or EFT, or offline with cash or a check. A section 206 contains text boxes which enable the interested party to input required order information, such as the interested party's name, address and phone number. If the interested party is paying by credit card or EFT, and the interested party's delivery address is different from the interested party's valid credit card or EFT address, then a section 207 enables the interested party to input his or her correct credit card or EFT address so that the order may be approved by the facilitator's third party processor. If the interested party is paying by credit card or EFT, then a section 208 enables the interested party to indicate, via radio boxes, which particular credit card or EFT method of payment is being used (e.g. Mastercard, Visa or ATM card). Section 208 also includes textboxes which enable the interested party to input his or her correct credit card or EFT account number, as well as the expiration date for each type of credit card or EFT card being used. A section 209 contains a textarea box which enables the interested party to set forth any special delivery or preparation instructions which are applicable to the interested party. Finally, a section 210 contains an order submission button, which, when clicked, submits the interested party's order to the facilitator's server engine for subsequent fulfillment. Alternatively, section 210 contains a cancel button which enables the interested party to cancel the order.

One skilled in the art will recognize the order data form illustrated in FIG. 2, along with its component parts, as a conventional ordering form. Such a form enables all relevant ordering information to be transmitted to server system 101 where the details of the order may inputted into order database 104, as well as passed on to various other components of the block diagram illustrated in FIG. 1. Thus, the order data form illustrated in FIG. 2 sets forth all of the information necessary for an order to be processed within the context of the present invention no matter which participating merchant is involved, or what goods or services are ordered, or what method of payment is used.

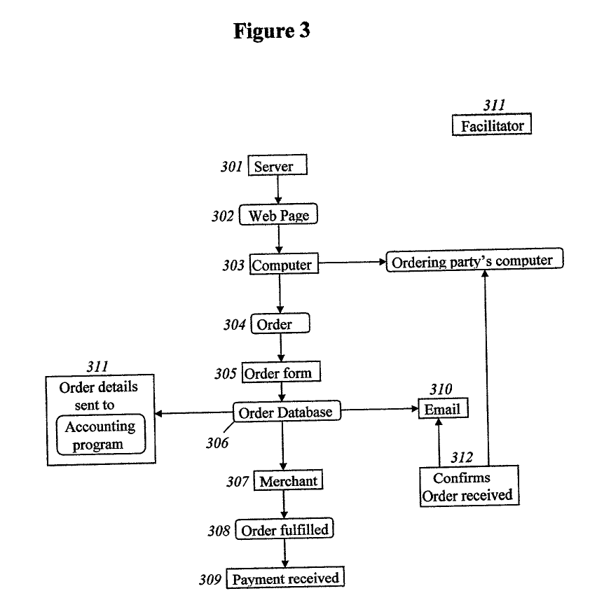

FIG. 3 is a flow chart of a routine for enabling and processing online transactions where a merchant receives direct remuneration in satisfaction of a completed transaction. The flow chart tracks a server 301 downloading a web page 302 to an ordering party's computer 303. The ordering party then generates an order 304, on an order form 305, which is transmitted back to an order database 306. After the details of order 304 are entered into order database 306, an email 310 is sent to the ordering party confirming in step 312 that order 304 has been received and is being filled. The relevant details of order 304 are also sent to a merchant 307 which fulfills order 304 in step 308 by providing the ordered items or services to the ordering party. Upon fulfillment, the ordering party then pays merchant 307 directly by means of cash, check or some other method of direct exchange. In the final step in the ordering process, the relevant details of order 304 are formatted in a tab delimited manner and tagged, or organized with predefined headings, and then sent to an accounting program 311, which may be a general accounting based application which is maintained on server 301, or may be maintained elsewhere. Once order 304's transactional details are imported into accounting program 311, they are then tracked and accounted for so as to enable a facilitator 313 to obtain payment for services rendered with respect to order 304, as well as to enable facilitator 313 and relevant merchant to derive operational data from order 304 standing alone, or in combination with other fulfilled orders. This routine, thus, illustrates the manner in which orders, which have been paid offline, are processed up until the point that they are accounted for in an integrated environment with orders which are paid online.

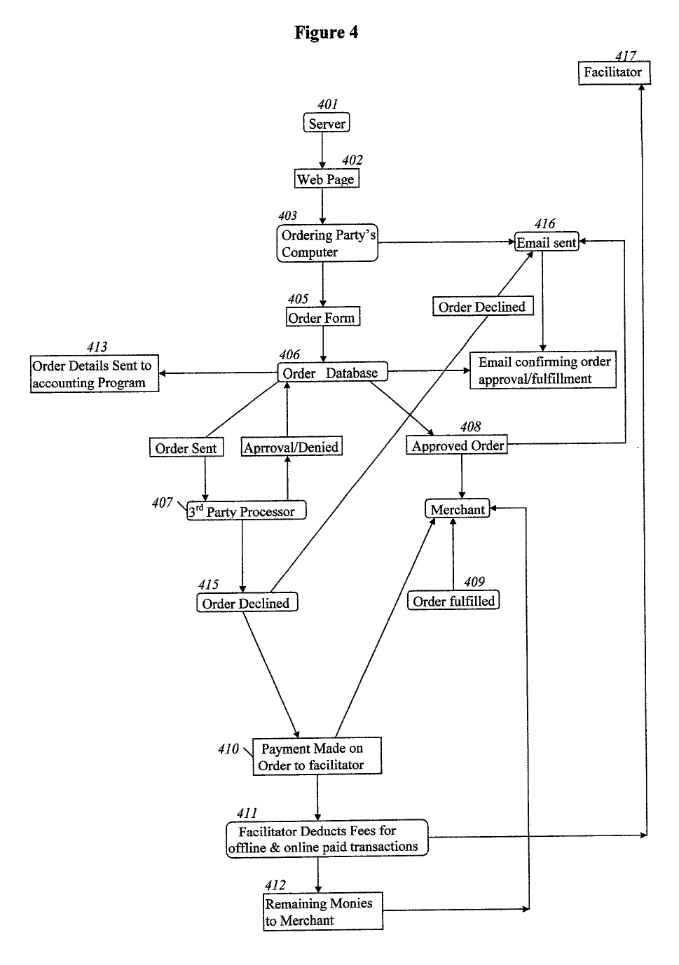

FIG. 4 is a flow chart of a routine for enabling and processing online transactions where a facilitator 417 receives remuneration in satisfaction of a completed transaction, as opposed to offline transactions where the merchant receives direct payment. As with FIG. 3, the flow chart tracks a server 401 downloading a web page 402 to an ordering party's computer 403. The ordering party then generates an order 404, on an order form 405, which is transmitted back to an order database 406. At this point, the routine illustrated here deviates from the routine illustrated in FIG. 3. In the within routine, order 404's details, which are set forth on the order form 405, are then sent to a third party processor 407. Third party processor 407 then processes order 404 depending on the type of credit card or EFT payment method used (e.g. American Express, Discover or Star ATM). If the order is declined, then a message is sent to the ordering party in step 415 which informs the ordering party that his or her order has been declined. Typically such a message will also include the details of why the order has been declined. The same denial information is sent to order database 406 so as to be recorded with order 404's details which were previously recorded in order database 406 at the beginning of the process. On the other hand, if order 404 is approved, then order 404 is sent to a merchant 408. At the same time, an email 414 is sent to ordering party's computer 403 which confirms to the ordering party, in step 415, that his or her order 404 has been approved and is being fulfilled. Merchant 408 then fulfills order 404 in step 409 by providing the goods or services ordered to the ordering party.

In step 410, payment on order 404 is remitted to facilitator 417 by third-party processor 407. Facilitator 417. Periodically thereafter, the relevant details of order 404 are formatted in a tab delimited manner and tagged, or organized with predefined headings, and then sent to an accounting program 413, which is present on server 301. Once order 404's transactional details are imported into accounting program 413, they are then tracked and accounted for so as to enable a facilitator 417 to obtain payment for services rendered with respect to both offline orders, such as order 304, and online orders, such as order 404. Accounting program 413, will also enable facilitator 417, along with any relevant merchant, or combination thereof, to track data associated with order 304, standing on its own, or in combination with other fulfilled orders.

After order 304 and order 404's details are imported into accounting program 413, facilitator 417 is then able to process both orders so that fees which are due facilitator 417 are deducted from the monies remitted to facilitator in step 410. This occurs in a step 411. After such fees, for both offline and online paid transactions, are deducted, the remaining monies are remitted to merchant 408 in step 412. This routine, thus, demonstrates how a facilitator may receive payment on any type of transaction, no matter whether it is paid online or offline, without having to invoice a participating merchant. At the same time, the routine illustrates how transactional costs can be substantially reduced by pooling processed online orders for an array of merchants through a single processing gateway.

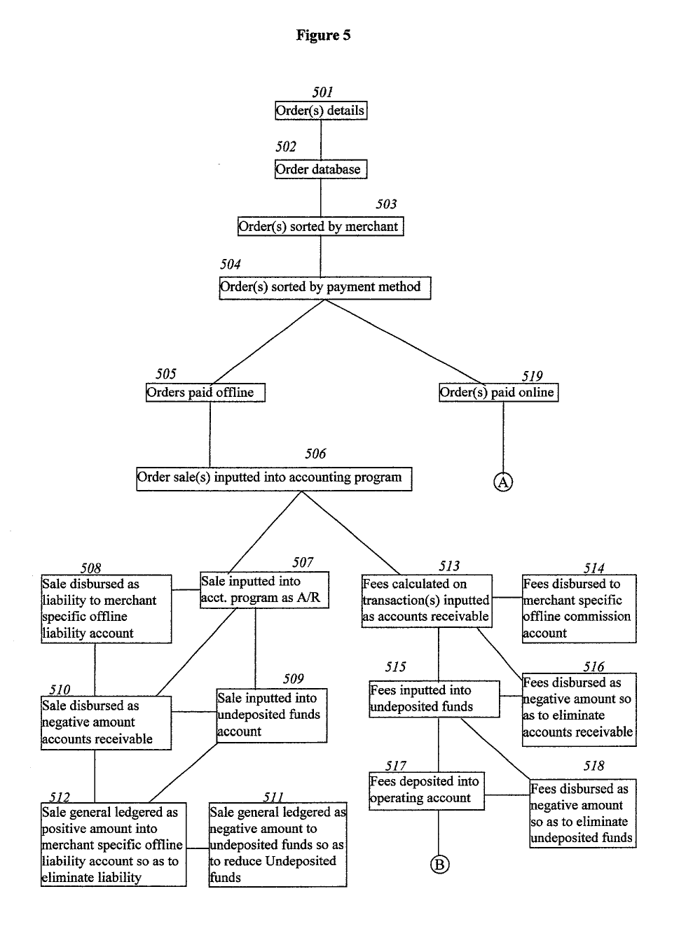

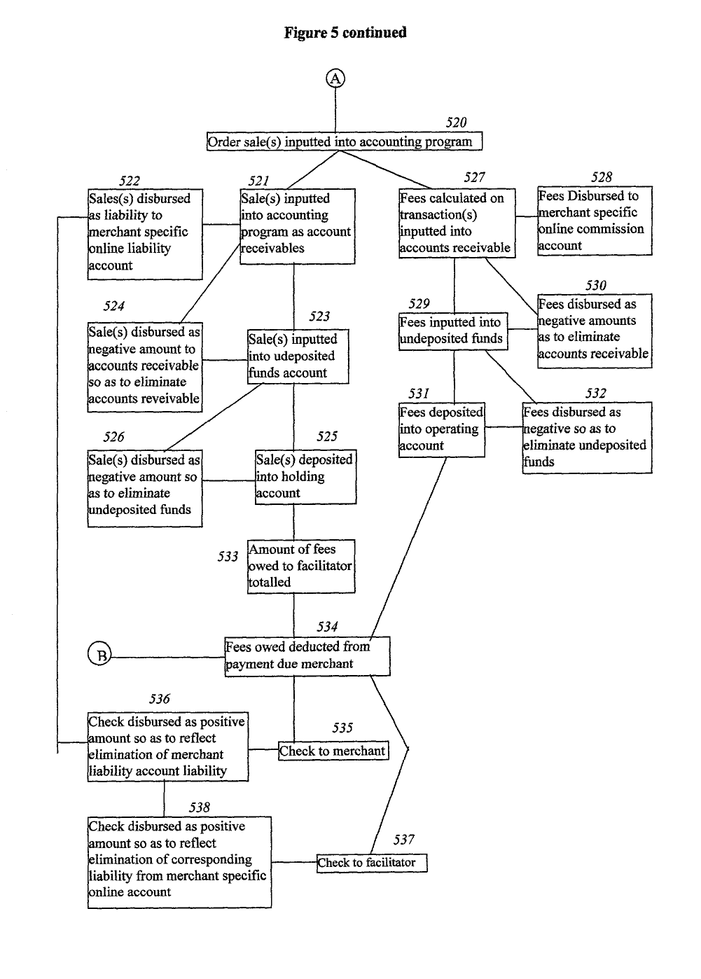

FIG. 5 is a flow chart illustrating a routine for tracking, finalizing, and accounting for payments, including bidirectional payments, on online transactions in an integrated single facilitator enabled online environment. The flow chart tracks the accounting end of the routines set forth in FIGS. 3 and 4 for offline and online remunerated transactions. The flow chart starts with order details 501 being inputted into an order database 502. Order details 501, may be the details for one order or for a number of orders. Order details 501 are then sorted in a step 503 by the particular merchant they apply to. In a step 504, order details 501 are then sorted by whether they were paid offline to a merchant or online to the facilitator.

If paid offline, order details 501 are then batched together in a step 505 and programmed into an accounting program in a step 506. Once programmed into the accounting program in step 506, the transactional details contained within order details 501 are then structured in the following manner. In a step 507, offline sales are inputted into the accounting program as accounts receivable. In a step 508, the offline sales are disbursed as a liability into a merchant specific liability account, which is generated for the merchant whose order details 501 have been sorted pursuant to step 503. In a step 509, the offline sales are inputted into an undeposited funds account, as an undeposited funds transaction, to reflect the fact that the offline sales have not actually been transmitted into a checking account which is controlled by the facilitator. In a step 510, the offline sales are disbursed as a negative amount to the accounts receivable account so as to eliminate the sales from accounts receivable. In a step 511, the offline sales are inputted as a negative general ledger transaction, which serves to eliminate the sales from undeposited funds. In a step 512, the offline sales are inputted as a positive general ledger disbursement, which is tied to the merchant specific liability account referenced in step 508 and which serves to eliminate the liability remaining in the liability account referenced in step 508. In a step 513, the facilitator's fee for enabling the orders, which are referenced in, and batched pursuant to, step 505, is calculated and then inputted into the accounting program as accounts receivable. In a step 514, the facilitator's fee is disbursed as an asset into a merchant specific offline commission account, or, alternatively, into a general offline commission account with the specific transaction being classified by the merchant it applies to. Disbursing the facilitator's fee in either of these ways enables such fees to be tracked by the merchant they apply to, or across an array of merchants, so that the facilitator's profits can be determined generally or on a merchant by merchant basis. In a step 515, the facilitator's offline fee is inputted into an undeposited funds account, as an undeposited funds transaction, in order to reflect the fact that the fee has not yet been actually transmitted into a facilitator controlled checking account. In a step 516, the facilitator's offline fee is disbursed as a negative amount to the accounts receivable account so as to eliminate the fee from accounts receivable. In a step 517, which takes place in conjunction with online sales being inputted into the accounting program at a step 520, the facilitator's offline fee is inputted into the facilitator's operating account, as a deposited sum. In a step 518, the facilitator's offline fee is disbursed as a negative amount to the undeposited funds account to eliminate the fee from the undeposited funds account.

If orders set forth in step 503 are paid online, then they are sorted in step 504 and separately batched together in a step 519 and programmed into an accounting program in a step 520. Once programmed into the accounting program in step 520, the transactional details contained within order details 501 are then structured in the following manner. In a step 521, online sales are inputted into the accounting program as accounts receivable. In a step 522, the online sales are disbursed as a liability into the afore-referenced merchant specific liability account, which is generated for the merchant whose order details 501 have been sorted pursuant to step 503. In a step 523, the online sales are inputted into an undeposited funds account, as an undeposited funds transaction, to reflect the fact that the online sales have not yet actually been transmitted into a checking account which is controlled by the facilitator. In a step 524, the online sales are disbursed as a negative amount to the accounts receivable account so as to eliminate the sales from accounts receivable. In a step 525, the online sales, which have been received remitted to the facilitator by third party processor 407, are inputted as a deposit into a holding account. In a step 526, the online sales are disbursed as a negative amount to the undeposited funds account so as to eliminate the sales from undeposited funds.

In a step 527, the facilitator's fee for enabling the orders, which are referenced in, and batched pursuant to, step 519, is calculated and then inputted into the accounting program as accounts receivable. In a step 528, the facilitator's fee is disbursed as an asset into a merchant specific offline commission account, or, alternatively, into a general offline commission account with the specific transaction being classified by the merchant it applies to. In a step 529, the facilitator's online fee is inputted into an undeposited funds account, as an undeposited funds transaction, in order to reflect the fact that the fee has not yet been actually transmitted into a facilitator controlled checking account. In a step 530, the facilitator's online fee is disbursed as a negative amount to the accounts receivable account so as to eliminate the fee from accounts receivable. In a step 531, which takes place in conjunction with offline sales being inputted into the accounting program at a step 506, the facilitator's offline fee is inputted into the facilitator's operating account, as a deposited sum. In a step 532, the facilitator's online fee is disbursed as a negative amount to the undeposited funds account to eliminate the fee from the undeposited funds account.

In a step 533, the total amount of both offline and online fees calculated pursuant to steps 513 and 527 are totaled together. In a step 534, the fees totaled pursuant to step 533 are then deducted from the sum which was reflected as being deposited into the facilitator's holding account in step 525. In a step 535, the amount remaining, after deduction of the facilitator's fees pursuant to step 534, is then remitted to the merchant pursuant to a check which is automatically generated by step 535. This check is set forth in step 535 as a negative amount with respect to the facilitator's holding account so as to reflect the fact that the holding account no longer holds the funds which are being withdrawn pursuant to the check. In a step 536, this check is disbursed as a positive amount to the merchant specific liability account referenced in step 522 so as to eliminate a portion of the liability in the liability account referenced in step 522. In a step 537, a check to the facilitator is automatically generated in the amount of the fees due the facilitator pursuant to steps 513 and 527. Pursuant to step 537, this check is set forth in step 537 as a negative amount with respect to the facilitator's holding account so as to reflect the fact that the holding account no longer holds the funds which are being withdrawn pursuant to the check. In a step 538, the fees paid to the facilitator are disbursed as a positive amount to the merchant specific liability account referenced in step 522 so as to eliminate the remaining amount of the liability contained in the liability account referenced in step 522.

Thus, this process results in both offline and online transactions being properly tracked and account for on a merchant by merchant basis, while at the same time enabling a facilitator to pool and account for online orders which are transmitted through a single transactional gateway. Monies received from third party processors in satisfaction of online orders may then, in turn, be used, up front, to satisfy any order enabling fees a facilitator may charge for providing online ordering sites for participating merchants. Operating in this way, merchants benefit because they are provided with an online gateway for conducting business, which costs substantially less to them than if they had to set up their own online gateway for accepting orders. Facilitators, in turn, benefit because the process set forth in the present invention enables them to receive payment up front for orders no matter whether they are paid offline to a participating merchant, or line to the facilitator. Finally, both the facilitator and the merchants benefit because their transactional costs with respect to credit card purchases and other online orders are substantially reduced as a result of the pooling arrangement which is enabled by the present invention.

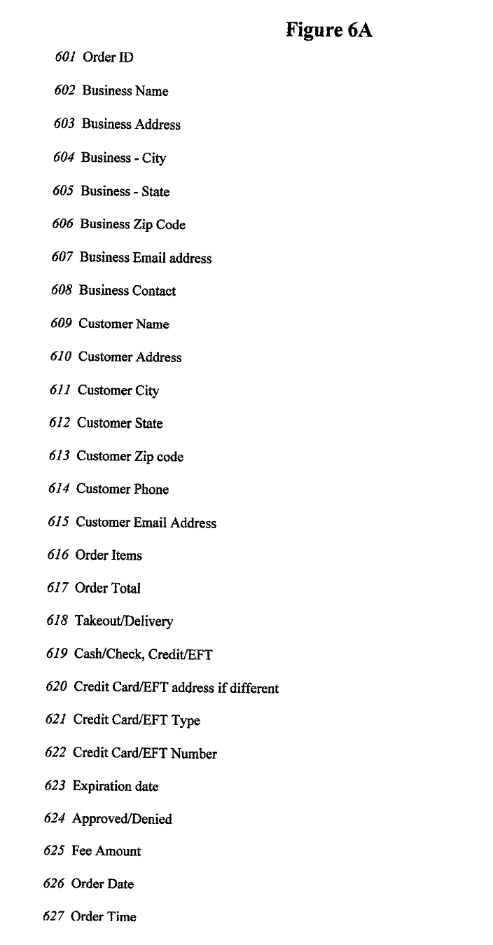

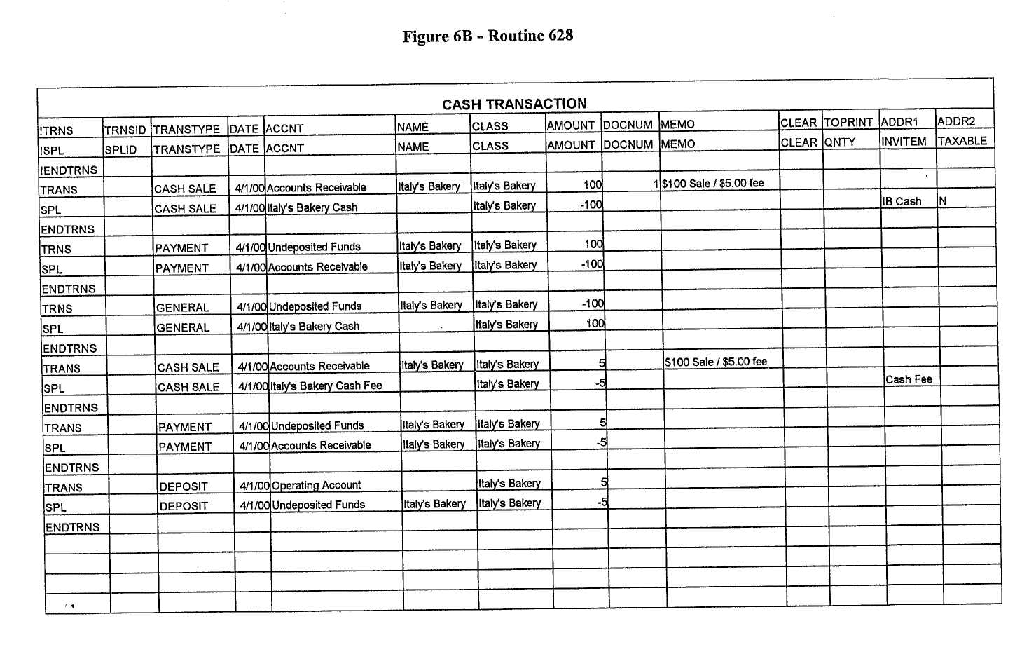

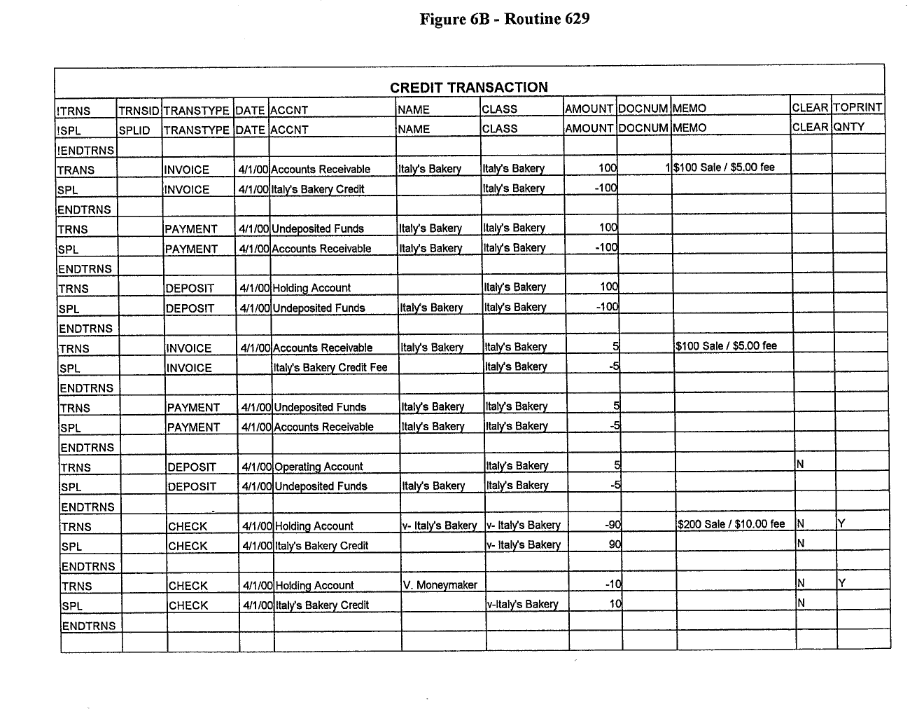

FIG. 6A illustrates a database routine which lists specific elements of an order which has been submitted, by an interested party, to a facilitator's order database, for processing by a merchant. The elements of the order are set forth in a text format, which would enable relevant and/or required information to be extracted from the database within which the text format is contained, and then used for purposes of completing orders and implementing and finalizing accounting procedures, including the payment of monies due the facilitator and participating merchants. The elements of such an order are arrayed in the present illustration of the database routine as follows. An element 601 contains a order identification code for the specific order which has been entered into the facilitator's order database 104. An element 602 contains the unique merchant's identifier, such as a name. An element 603 contains the merchant's address. An element 604 contains the city where the merchant is located. An element 605 contains the state where the merchant is located. An element 606 contains the zip code for the merchant. An element 607 contains the merchant's email address. An element 608 contains the name of the contact for the merchant. An element 609 contains the name of the ordering party. An element 610 contains the ordering party's address. An element 611 contains the city where the ordering party is located. An element 612 contains the state where the ordering party is located. An element 613 contains the ordering party's zip code. An element 614 contains the ordering party's phone number. An element 615 contains the ordering party's email address. An element 616 contains the items or services the ordering party is ordering. An element 617 contains the total amount of the ordering party's order. An element 618 sets forth whether ordered items are to be picked up or delivered. An element 619 sets forth whether the order is being paid for with cash, or by check, or credit card or EFT card. An element 620 contains the address for the ordering party's credit card or EFT card if different from the ordering party's delivery address. An element 621 contains the type of credit card or EFT card being used by the ordering party. An element 622 contains the credit card or EFT card number. An element 623 contains the expiration date for the credit card or EFT card being used. An element 624 sets forth whether a credit card or EFT card was approved or declined. An element 625 contains the amount of the facilitator's fee on the order. An element 626 contains the date the order was submitted. And an element 627 contains the time the order was submitted.

FIG. 6B illustrates accounting routines which may be used in an embodiment of the present invention for purposes of processing, tracking, finalizing, and accounting for payments. A routine 628 illustrates an accounting routine for processing orders which have been paid for in an offline environment (e.g. with cash or by check). Routine 628 may be utilized by being imported into an accounting program so as to carry out the routine set forth in FIG. 5 for effectuating the processing, tracking, finalizing and accounting for of orders which have been paid for in such an offline environment. A routine 629, in turn, illustrates an accounting routine for processing orders which have been paid for in an online environment (e.g. with a credit card or EFT card). Routine 629 may be utilized in the same manner as routine 628 by being imported into an accounting program so as to carry out the routine set forth in FIG. 5 for effectuating the processing, tracking, finalizing and accounting for of orders which have been paid for in an online environment. Both routines 628 and 629, when utilized together, enable a single facilitator to process, track, finalize and account for orders in an integrated environment and across an array of merchants. Further routines 628 and 629 enable a facilitator to process each and every order which is placed through the facilitator no matter whether an order is paid for offline or online.

In conclusion, the present invention enables a single proprietor to process an array of orders for an array of merchants, without the facilitator having to invoice for the online services provided to each merchant. At the same time, the present invention enables orders, which are paid for online, to be processed through a single transactional gateway, thus resulting in reduced transactional costs to both the facilitator and participating merchants. Indeed the greater the number of orders which are processed, the lower the transactional cost is for each order. As a result, the present invention sets forth an elegant method and system for enabling merchants, such as small businessmen, to go online and sell their goods or services, while at the same time pooling their respective customers to obtain reduced online fees.

The aforedescribed embodiments of the present invention should not be construed to limit the scope of the invention, particularly since many changes and modifications may be made to the present invention without departing from its essential characteristics. As a result, because it is not intended to limit the present invention to the forms and applications specifically enumerated and described herein, all suitable modifications and equivalents may be regarded as falling within the scope of the invention as set forth in the appended claims and their equivalents.

What is claimed is:

1. A method for amalgamating transactions received via an electronic network on behalf of an array of participants comprising:
electronic means for enabling goods and/or services to be ordered via a computer-networked system which is implemented by a facilitator;
under the control of a facilitator, electronically enabling goods and/or services to be purchased separately by reference to each particular participant offering said good and/or services for sale and then amalgamating orders received for the goods and/or services offered for sale by participating parties and processing said orders through a single transactional gateway;
sorting means for manipulating, selecting and extracting ordering information from sets of orders which have been amalgamated and processed;
an electronic system for submitting particular order information which has been processed to applicable participants who then fulfill the orders for the particular goods and/or services which have been specifically ordered from them through the system;
whereby transactional costs associated with electronic transactions through a computer-networked environment are reduced for participants; and
whereby participants receive orders only after said orders have been processed and approved, thus resulting in the elimination of ordering mistakes and delays which occur as a result of multiple transfers of the same sets of ordering data.

2. The method according to claim 1, further including the step of tracking, sorting and manipulating order information which is maintained in a database.

3. The method according to claim 2, further including the step of enabling previous order information to be recalled, displayed and/or manipulated in order to aid participants to improve diverse aspects of their business, as well as to allow customers to retreive records of previously ordered items and/or services.

4. The method according to claim 1, further including the step of amalgamating credit card sales for processing, tracking, sorting and/or manipulation.

5. The method according to claim 1, further including the step of amalgamating electronic transfer fund purchases for processing, tracking, sorting and/or manipulation.

6. The method according to claim 1, further including the step of amalgamating sales sales for processing, tracking, sorting and/or manipulation, wherein purchases are communicated and made via an electronic device.

7. The method according to claim 2, further including the step of sending order information which has been amalgamated, processed, and then separated by the applicable participant, to the participant by electronic mail and/or facsimile machine, and/or wireless communication device.

8. The method according to claim 7, further including the step of enabling order information, which has been amalgamated, processed and separated, to be displayed via online interfaces and made downloadable, through said interfaces, for applicable participants.

9. The method according to claim 8, further including the step of enabling order information which has been amalgamated, processed and separated to be accessed in an online environment by means of a password system.

10. The method according to claim 9, further including the step of enabling order information to be accessed and downloaded directly into software accounting programs which are maintained by participating parties.

11. A method for enabling facilitators which amalgamate electronic orders for an array of merchants which are received via an electronic network to receive direct remuneration for all types of orders received comprising:
means for enabling orders to be tracked, sorted and manipulated based, among other things, on whether they have been paid for in a direct electronic manner, such as by a credit card or or EFT card, or indirectly by payment of cash or check to a participating merchant;
amalgamating orders which are paid for in a direct electronic manner and then processing said orders through a single transactional gateway;
receiving payment for orders which are paid for in a direct electronic manner and then applying those finds which are received to all other orders which have been enabled and tracked by the facilitator, no matter whether said orders have been paid for in cash, or by check, or by other means, directly to a participant who actually fulfilled the order made through the implemented electronic network system;
remitting funds to a participant which remain after the deduction of fees due the facilitator for all of the orders which were enabled by the facilitator; and
whereby a facilitator receives direct payment for the services provided to participants without having to invoice said participants on an accounts receivable type basis, which would otherwise require the facilitator to wait for payment.

12. The method according to claim 11, further including the step of deducting fees due for services provided to a participant only after a sale of the participants' goods and/or services has occurred so that participants only incur transactional costs after electronic sales have been finalized and payments on said orders have been processed and received by the facilitator.

13. The method according to claim 11, further including the step of providing additional services which are in addition to enabling transactions to take place in an electronically networked environment, and then deducting payments due for these services from payments which have been received for orders which have been finalized and processed by the facilitator for the participant.

14. The method according to claim 11, further including the step of enabling amalgamated data which has been processed and sorted to be exported and/or imported into software accounting programs.

15. The method according to claim 14, further including the step of providing and utilizing programmable computer language tags in order to enable processed and sorted transactional data to be tracked and accounted for in a software accounting program.

16. The method according to claim 15, further including the step of tracking and accounting for goods and services which are made online and/or offline, whereby participants are treated as both customers and vendors for accounting purposes.

17. The method according to claim 16, further including the step of utilizing a chart of accounts whereby liability accounts and deposit accounts are created for each participating party so that transactional data, including fees due and monies owed, can be tracked, sorted, manipulated and accounted for.

18. The method according to claim 14, further including the step of utilizing programming routines to enable transactional data, including payments, to be tracked, sorted, manipulated and accounted for across an array of merchants no matter whether payments have been finalized in an online or offline environment.

19. The method according to claim 17, further including the step of utilizing separate liability and deposit accounts for each participant so that transactional data can be tracked separately and/or cumulatively by the particular party involved, as well as by the type of order or service involved.

20. The method according to claim 18, further including the step of utilizing a programmable routine whereby orders are sorted by payment type, as well as by participant, with participants being remitted monies due after the deduction of fees which have been incurred on sales which have been finalized in either in an online or offline environment.
